(19) United States
(12) Patent Application Publication
(10) Pub. No.: US 2015/0012208 A1
(43) Pub. Date: Jan. 8, 2015

(54) TRIP ROUTING SOFTWARE AND METHOD FOR IDENTIFYING AND CONTACTING CONTACTS WITHIN A PREDETERMINED DISTANCE FROM THE TRIP ROUTE

(71) Applicant: Russel Aaron Abrams, Bexley, OH (US)

(72) Inventor: Russel Aaron Abrams, Bexley, OH (US)

(21) Appl. No.: 13/934,188

(22) Filed: Jul. 2, 2013

(51) Int. Cl. G01C 21/00

(52) U.S. Cl. CPC G01C 21/00
USPC 701/400

(57) ABSTRACT

An application and method can takes a trip route and maps the addresses of a user's contacts along the route. The application and method can identify which contacts are within a predetermined distance from the route, maps them, and can instantly email these contacts to notify them that the user of the application will be passing by their location. The contacts can be manually entered by the user or can be imported from various email providers, various social media platforms, or other contact storing programs. The application can periodically synchronize with the contact sources to be sure the information in the application is current.

### BACKGROUND OF THE INVENTION

The present invention relates to trip routing software and methods and more particularly, to an application that takes a trip route and maps the addresses of a user's contacts along the route. The application identifies which contacts, sites, customers, leads, and the like, are closest to the route, maps them and can instantly email them to notify them that the user will be passing by them during their travels.

Often, after returning from a trip, a traveler realizes that they missed a contact that they might have passed or they might have been nearby another contact at their destination. It can be time consuming to manually look up all of a user's contacts to identify their location and if they will be available when the user will be traveling near their location. Moreover, once the potential contacts close along a route are manually identified, the user must then contact each of these contacts to see if they are available to meet.

Conventionally mapping and routing software can map a user's contacts and find contacts close to the user's location. However, these conventional applications cannot map contacts along a route and send emails to all of these contacts identified within a predetermined distance from the route of travel.

As can be seen, there is a need for an application that can determine a route of travel between a start point and an end point, determine contacts that are close to that route of travel, and contact the contacts close to the route of travel to set up an appointment.

### SUMMARY OF THE INVENTION

In one aspect of the present invention, a method comprises entering a destination location into an application running on a computing device; identifying user contacts within a predefined distance from a trip route to the destination location on a display of the computing device; contacting the identified user contacts by electronic communication; and updating the trip route to include identified user contacts that choose to set up a meeting.

In another aspect of the present invention, a method comprises loading the user contacts into the application running on a computing device; entering a destination location into the application; entering an origin location into the application; identifying user contacts within a predefined distance from a trip route from the origin location to the destination location on a display of the computing device; selecting one or more of the identified user contacts; contacting the selected identified user contacts by electronic communication; and updating the trip route to include the selected identified user contacts that choose to set up a meeting.

These and other features, aspects and advantages of the present invention will become better understood with reference to the following drawings, description and claims.

### BRIEF DESCRIPTION OF THE DRAWINGS

FIG. 1 is a schematic flow chart describing an overall method according to an embodiment of the present invention;

FIG. 2 is a flow chart describing a method for identifying contacts along a route (also referred to an a contact route proximity evaluation), according to an exemplary embodiment of the present invention;

FIG. 3 is a graphic schematic representation of the first two steps shown in FIG. 2;

FIG. 4 is a graphic schematic representation of the first three steps shown in FIG. 2;

FIG. 5 is a graphic schematic representation of the contact route proximity evaluation shown in FIG. 2;

FIG. 6 is a schematic representation of various options available from a home screen of the method and application of the present invention; and

FIG. 7 is a schematic representation of various options available from a profile screen of the method and application of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an application and method for taking a trip route and mapping the addresses of a user's contacts along the route. As used herein, the term “contacts” can refer to various items such as contacts, sites, customers, leads, and the like. The application and method can identify which contacts are within a predetermined distance from the route, maps them, and can instantly email these contacts to notify them that the user of the application will be passing by their location. The contacts can be manually entered by the user or can be imported from various email providers, various social media platforms, or other contact storing programs. The application can periodically synchronize with the contact sources to be sure the information in the application is current.

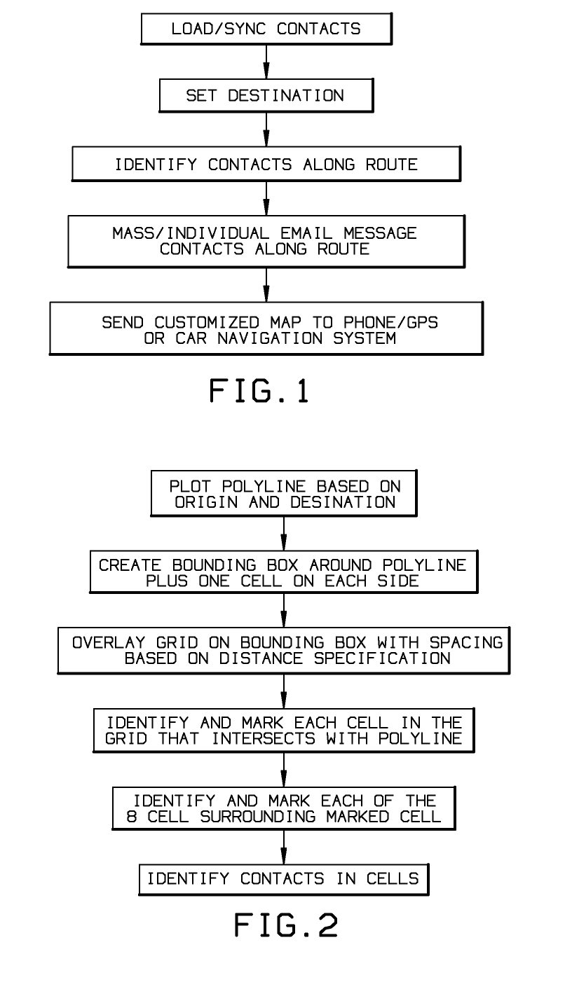

Referring to FIG. 1, in a simplified form, the method of the present invention can be broken down into a four step process. The first step is to load and synchronize contacts. The next step is to set a destination in the application. This destination could be a city, address in a city, or a contact's address. In the third step, the application will identify contacts of the user within a predetermined distance from the route. The user can have the option to select some or all of the identified contacts at this stage. A final step is to email and schedule meetings with the contacts identified and/or selected that are along the route. The email message to the identified contacts can be a standard message or can be customized for each contact. In some embodiments, the software application can save personalized emails for each contact and can use these personalized emails when making contact with the identified contacts. An optional final step could be to send a customized map to a phone, global positioning system (GPS) or car navigation system to aid the user along their route to the customers that have replied to make an appointment.

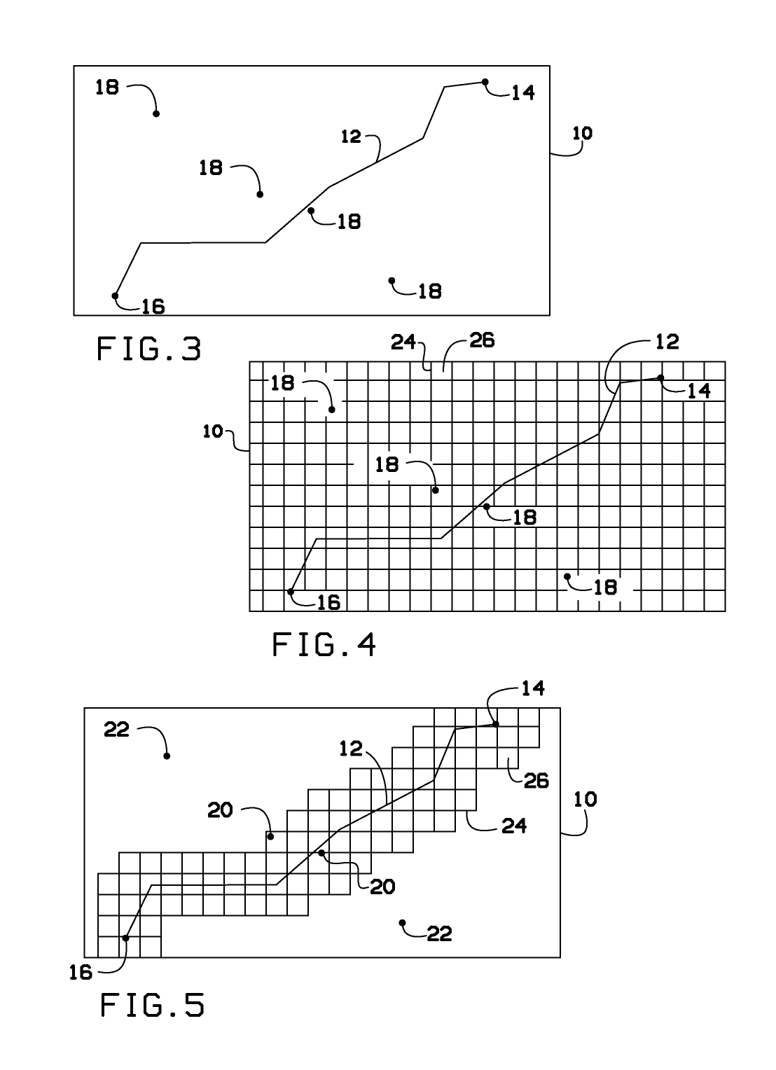

Referring now to FIGS. 2 through 5, a method for identifying contacts along a trip route is described. In this method, which follows a RouteBoxer logic, a polyline 12 is plotted between an origin 14 and a destination 16. A bounding box 10 is placed around the polyline 12, as shown in FIG. 3. Contacts 18 can be shown that are within the bounding box 10. A grid 24 is overlaid on the bounding box. Each grid cell 26 of the grid can have a spacing based on a user-selected distance specification. This distance specification can determine an approximate maximum distance range within which contacts need to be located in order to be contacts identified as being accessible from along the route. This grid 24 is shown in FIG. 4.

Each grid cell 26 that contains the polyline 12 is identified and each of the eight cells surrounding each grid cell that contains the polyline is selected, as shown in FIG. 5. Contacts 18 within the remaining grid cells 26 of FIG. 5 are identified as contacts within a specified distance 20, and contacts 18 outside the remaining grid cells are contacts not within the specified distance 22.

The contacts within the specified distance 20 (also referred to as identified contacts 20) can be provided to the user so that the user can select some or all of the contacts to send an email. In some embodiments, the contact's information can be displayed, such as the contact's business, source of the contact (such as Salesforce, Zoho, Linkdin, gmail, a .csv file, or the like), and the like. The specified distance 20 can be typically chosen from among various distances, such as 0.25 mile, 0.5 mile, 1 mile, 5, 10, 15, or 20 miles.

Once the identified contacts are selected, the user can send a standard email, a pre-saved email for that particular contact, or a customized email to each of the selected contacts. Once a meeting request reply has been received, the user can mark those as stops along their route. The end route can be exported to a phone, mobile device, GPA, car navigation system or the like. As additional contacts reply to confirm meetings, the trip route can be updated accordingly to reflect the additional stops.

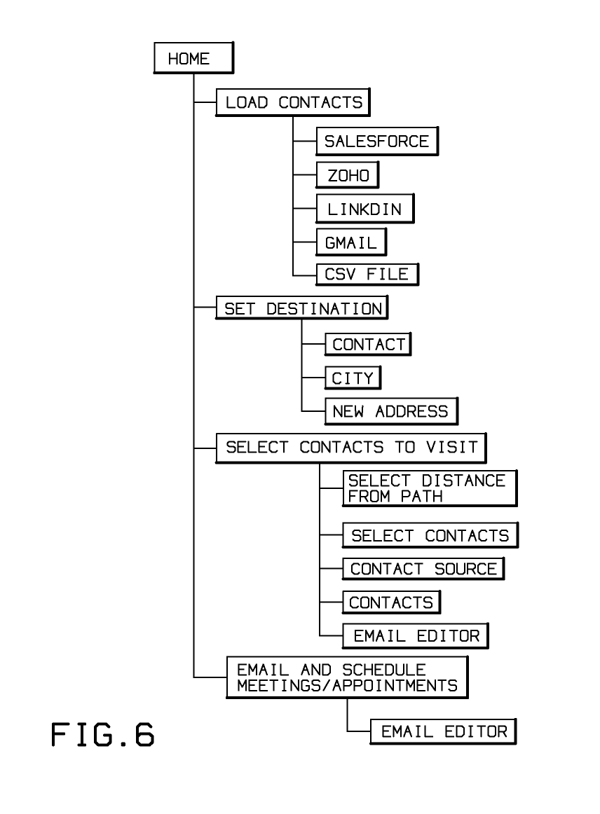

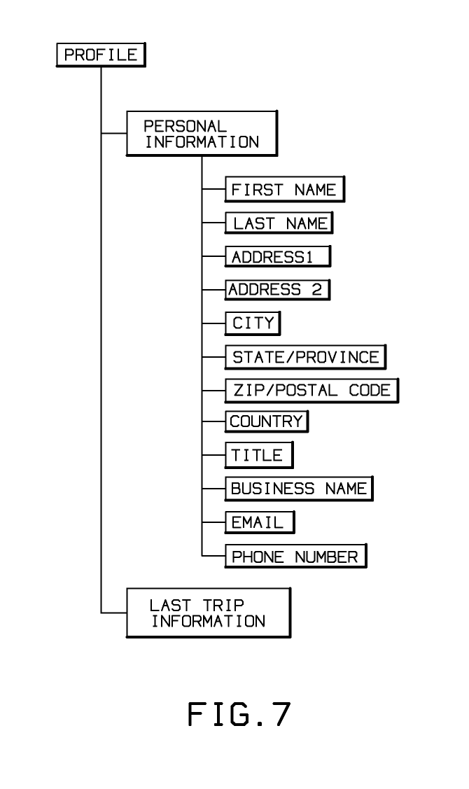

As shown in FIG. 6, the application can include a profile management area where the user can see and/or edit their personal information as well as see prior trip information.

The application can include options to view prior trips, see contacts met with on prior trips and analyze contacts that haven't been contacted for a period of time.

It should be understood, of course, that the foregoing relates to exemplary embodiments of the invention and that modifications may be made without departing from the spirit and scope of the invention as set forth in the following claims.

What is claimed is:

1. A method comprising:
entering a destination location into an application running on a computing device;
identifying user contacts within a predefined distance from a trip route to the destination location on a display of the computing device;
contacting the identified user contacts by electronic communication; and
updating the trip route to include identified user contacts that choose to set up a meeting.

2. The method of claim 1, further comprising entering an origin location into the application.

3. The method of claim 1, further comprising loading the user contacts into the application running on a computing device.

4. The method of claim 1, wherein the user contacts are loaded into the application from at least one of an email account and a social media site.

5. The method of claim 1, further comprising synchronizing the user contacts with at least one user contact list.

6. The method of claim 1, wherein the electronic communication is email.

7. The method of claim 6, wherein the email is customizable for each of the user contacts.

8. A method comprising:
loading the user contacts into the application running on a computing device;
entering a destination location into the application;
entering an origin location into the application;
identifying user contacts within a predefined distance from a trip route from the origin location to the destination location on a display of the computing device;
selecting one or more of the identified user contacts;
contacting the selected identified user contacts by electronic communication; and
updating the trip route to include the selected identified user contacts that choose to set up a meeting.

9. The method of claim 8, further comprising synchronizing the user contacts with at least one user contact list.

10. The method of claim 8, wherein the electronic communication is email and the email is customizable for each of the user contacts.
